(19) United States
(12) Patent Application Publication
(10) Pub. No.: US 2026/0125056 A1
(43) Pub. Date: May 7, 2026

(54) SYSTEMS AND METHODS FOR GROUND TRAVEL SPEED CONTROL

(71) Applicants: Deere & Company, Moline, IL (US); Iowa State University Research Foundation, Inc., Ames, IA (US)

(72) Inventors: Shane M. Boden, Vinton, IA (US); William J. Vande Haar, Janesville, IA (US); Alex J. Irlbeck, Templeton, IA (US); Sean McFadden, Boone, IA (US)

(21) Appl. No.: 18/938,909

(22) Filed: Nov. 6, 2024

(51) Int. Cl. B60W 30/14; B60W 50/038; B60W 50/08; B60W 50/14

(52) U.S. Cl. CPC B60W 30/143; B60W 50/038; B60W 50/082; B60W 50/14; B60W 2300/15; B60W 2520/10; B60W 2520/26; B60W 2520/28; B60W 2720/28

(57) ABSTRACT

A ground control system for controlling a wheel speed and a ground travel speed of an agricultural machine. A user selected wheel slip aggressiveness level can provide a predetermined threshold for wheel slip. The actual ground travel speed and current wheel speed can be used to determine wheel slip. If the wheel slip does not exceed the predetermined threshold, a wheel speed command can be modified to increase wheel speed. However, if the slip exceeds the predetermined slip threshold, the ground speed control system may seek to maintain the current wheel speed. Optionally, if the wheel slip exceeds the predetermined threshold and another threshold associated with spinout prevention, the ground speed control system can modify a wheel speed command(s) for decreasing wheel speed. Changes to the wheel speed command can also be temporarily disabled, including in response to a determination that the machine is currently underpowered or performing certain tasks or maneuvers.

### FIELD OF THE DISCLOSURE

The present disclosure generally relates to ground travel speed control for agricultural vehicles, and, more specifically, to controlling ground and wheel speeds in response to variances in field dynamics.

### BACKGROUND

Agricultural vehicles, including construction vehicles and equipment, as well as combinations thereof, can be used to perform different agricultural and industrial tasks. For example, one or more agricultural vehicles can provide, or be part of, agricultural machines, including, but not limited to harvesters and windrowers, that can be utilized to plant crops, harvest crops, bale or otherwise collect crops, and spray or distribute crop inputs, such as, for example, fertilizer or chemicals, over a field or plants within a field.

### SUMMARY

The present disclosure may comprise one or more of the following features and combinations thereof.

In one embodiment of the present disclosure, a system is provided for controlling a wheel speed and a ground travel speed of an agricultural machine. The system can include a ground speed sensor configured to provide information for a determination of an actual ground travel speed of the agricultural machine and a wheel speed sensor configured to provide information for a determination of a current wheel speed of a ground engagement body of the agricultural machine. The system can also include at least one processor and a memory coupled to the at least one processor. The memory can include instructions that when executed by the at least one processor cause the at least one processor to receive a signal indicative of a selected first predetermined threshold for a wheel slip of the ground engagement body, and determine, using at least the actual ground travel speed and the current wheel speed, the current wheel slip. Further, the determination of the current wheel slip can be at least periodically updated to reflect a change in at least either or both the wheel speed and the actual ground travel speed. The memory can also include instructions that when executed by the at least one processor can cause the at least one processor to generate, if the current wheel slip does not exceed the selected first predetermined threshold for the wheel slip, a first wheel speed signal to increase the current wheel speed, the increase being based at least in part on an attempt to increase the current ground travel speed to attain a preselected speed setpoint. Additionally, the memory can include instructions that when executed by the at least one processor cause the at least one processor to generate, if the current wheel slip does exceed the first predetermined threshold, a second wheel speed signal to not modify the wheel speed.

In another embodiment of the present disclosure, a method is provided for controlling a wheel speed and a ground travel speed of an agricultural machine. The method can include receiving a signal indicative of a selected first predetermined threshold for a wheel slip of a ground engagement body of the agricultural machine, and determining, using at least an actual ground travel speed and a current wheel speed, a current wheel slip of an engagement body of the agricultural machine. The determined current wheel slip can be at least periodically updated to reflect a change in at least either or both the current wheel speed and the actual ground travel speed. If the current wheel slip does not exceed the selected first predetermined threshold, a first wheel speed signal can be generated to increase the current wheel speed, the increase being based at least in part on an attempt for the actual ground travel speed to attain a preselected speed setpoint. Additionally, if the current wheel slip does exceed the first predetermined threshold, a second wheel speed signal can be generated to not modify the current wheel speed.

These and other features of the present disclosure will become more apparent from the following description of the illustrative embodiments.

### BRIEF DESCRIPTION OF THE DRAWINGS

The disclosure contained herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates a representative agricultural machine having an agricultural vehicle coupled to an agricultural implement.

FIG. 2 illustrates a simplified block diagram of an exemplary ground speed control system for controlling a ground travel speed and a wheel speed of an agricultural vehicle.

FIG. 3 illustrates a simplified exemplary representation of a method involving control logic for a ground speed control system in connection with controlling a ground travel speed and a wheel speed of an agricultural vehicle.

FIG. 4A illustrates a graphical representation of field dynamics influencing an inability of an actual ground travel speed of an agricultural vehicle to attain a speed setpoint when a ground speed control system is disabled.

FIG. 4B illustrates the example scenario shown in FIG. 4A but wherein the ground speed control system is enabled to modify the wheel speed so that the ground travel speed is in closer alignment with the speed setpoint.

FIG. 5 illustrates a ground travel state chart for a ground speed control system.

FIGS. 6A, 6B, and 6C illustrate exemplary operations of a ground speed control system for when high, medium, and low slip aggressiveness levels are selected, respectively, and when a spinout prevention feature of the ground speed control system is enabled.

Corresponding reference numerals are used to indicate corresponding parts throughout the several views.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The ground travel speed at which an agricultural vehicle, including, for example, agricultural and construction vehicles or equipment, travels can be set in a variety of manners, including, for example, via a setting inputted by an operator of the vehicle. Such set ground travel speed can correspond to a desired rate of travel of the vehicle along an adjacent ground surface, including, for example, a prepared or unprepared ground or path in a field or road, such as, but not limited to, dirt, gravel, or paved roads, among other ground surfaces. For example, in certain situations, such a set ground travel speed can correspond to a desired rate of travel while an agricultural vehicle, for example, a tractor, is performing an agricultural operation in a field, including, but not limited to, an agricultural operation that utilizes one or more agricultural implements for planting, harvesting, spraying, windrowing, or baling operation, among other operations.

Attaining selected or desired ground travel speeds, as well as being able to repeatably attain such speeds consistently, can contribute to the quality of an associated job or functionality being performed using of the vehicle. For example, with respect to agricultural vehicles having, or coupled to, an agricultural implement used to conduct an agricultural operation, reducing, if not preventing, instances of fluctuations in ground travel speed can facilitate the implement being more frequently operated within the implement’s optimal operation range. Additionally, consistency in the ground travel speed of the agricultural vehicle can allow for more optimal tuning of implement subsystems, including with respect to tuning subsystems associated with either, or both, autonomous and mechanical systems. With respect to agricultural vehicles, consistent ground travel speed can also assist with management of field operations. For example, traveling at a generally consistent ground travel speed can aid in estimating the time until field work is completed, as well as with the accuracy of estimating the timing for a variety of other related operations. Yet, such estimates often rely on knowing, or accurately predicting, the true ground travel speed of the vehicle.

Setting a ground travel speed for a vehicle can involve a command being issued for one or more wheels, also referred to herein as ground engagement bodies, of the vehicle to operate at a particular, or constant, wheel speed. Such a commanded wheel speed however may not account for potential obstacles or factors that can adversely impair the ability of the agricultural vehicle to both attain and maintain the commanded wheel speed. For example, the commanded wheel speed may not account for variances in field dynamics, different tractor configurations, and/or machine or wheel slip, as well as combinations thereof, among other operational attributes. For instance, changes or variances in a moisture content or ground/soil hardness can impact the extent wheels may experience wheel slip while an agricultural vehicle is pulling an agricultural implement that is performing an agricultural operation. The failure to account for such potential operational attributes when determining the commanded wheel speed, and, moreover the impact such operational attributes can have on the extent wheels of the vehicle can experience wheel slip, can adversely impact timing estimates that are based at least on vehicle ground travel speed.

As discussed below, embodiments of the subject disclosure include systems and methods configured to manipulate the commanded wheel speed to at least assist in consistently actually achieving a particular, or preselected, ground travel speed for the travel of at least the agricultural vehicle. Further, embodiments discussed herein can eliminate reliance on attempts by an operator to correctly, and timely, make adjustments in the operation of the agricultural vehicle to attain a constant wheel speed, including, for example, reliance on efforts by the operator to adjust the ground travel speed or adjust a depth of an associated agricultural implement, among other adjustments. Moreover, embodiments discussed herein can eliminate reliance on attempts by operators to compensate for a variety of operational attributes, including changes in field dynamics, that can interfere with maintaining a constant wheel speed. Embodiments discussed herein can further facilitate varying a wheel speed to maintain a constant ground travel speed so that the need for considering at least certain operation attributes, such as, for example, wheel slip assumptions, can be eliminated in connection with determining time estimates, including time estimates related to completion of field work. Additionally, with respect to at least autonomous vehicles, the ability to attain a consistent ground travel speed can assist in syncing the ground travel speeds of multiple autonomous vehicles.

Embodiments of the subject disclosure also include systems and methods that can provide feedback as to a current machine state, and which can be used to monitor operational attributes to ensure the vehicle is operating within tolerable ranges. For example, embodiments discussed herein can monitor wheel slip to ensure the agricultural vehicle is operating within thresholds for a selected aggressiveness level for a current state of operation of the agricultural vehicle, such as, for example, a traction limited state of operation. According to certain embodiments, the different aggressiveness levels, and, moreover, the associated predetermined thresholds for wheel slip for each of the aggressiveness levels or ranges, can be user selected and/or user defined, and can depend, for example, on the field operation being, or to be, performed. Such selectable aggressiveness levels can be categorized in one or more of a plurality of levels, including, for example, one of a low, medium, or high category of aggressiveness levels, among other categories.

Embodiments discussed herein can also monitor and determine if a selected ground travel speed, which can also be referred to as a speed setpoint, cannot be achieved, including, for example, determine a selected ground travel speed is not attainable due to the vehicle at least temporarily having insufficient power to operate at the selected ground travel speed. Embodiments herein can also identify machine state changes, including, for example, changes based on either, or both, wheel slip and power restrictions. Such identified states can be communicated to an operator in one of more forms that can provide an indication as to whether an adjustment is to be made in an operating procedure. For example, an identification, including a determination, by the system that a vehicle is repeatably, or for more than a predetermined duration, operating in a power limited scenario while performing an operation using an agricultural implement, or tool, that is coupled to the vehicle can be used to determine the agricultural implement is being used too aggressively. For instance, with respect to a tractor performing an agricultural operation involving an implement extending into the ground surface, detection by the system of the tractor being operated in a power limited state that extends over a predetermined time period, or has entered into the power limited state a predetermined number of times within the predetermined time period, can be used to indicate that the agricultural implement is set to a depth that is too aggressive for the tractor, as at least currently configured.

At least certain attempts to overcome wheel slip in connection with operation of agricultural vehicles has included using larger, and/or heavier, agricultural vehicles. However, in addition to often costing more than smaller agricultural vehicles, larger / heavier agricultural vehicles can consume larger quantities of fuel, thereby increasing operational costs. However, using smaller / lighter agricultural vehicles can be associated with increased levels of wheel slip, which can adversely impact efficiency and operation times, as discussed above. Thus, embodiments of the subject application provide systems and methods for automatic adjustments in wheel speed to minimize wheel slip while also seeking to attain a degree of consistency in terms of operating the agricultural vehicle at, or around, a preselected speed of ground travel, or speed setpoint, as may be selected by an operator.

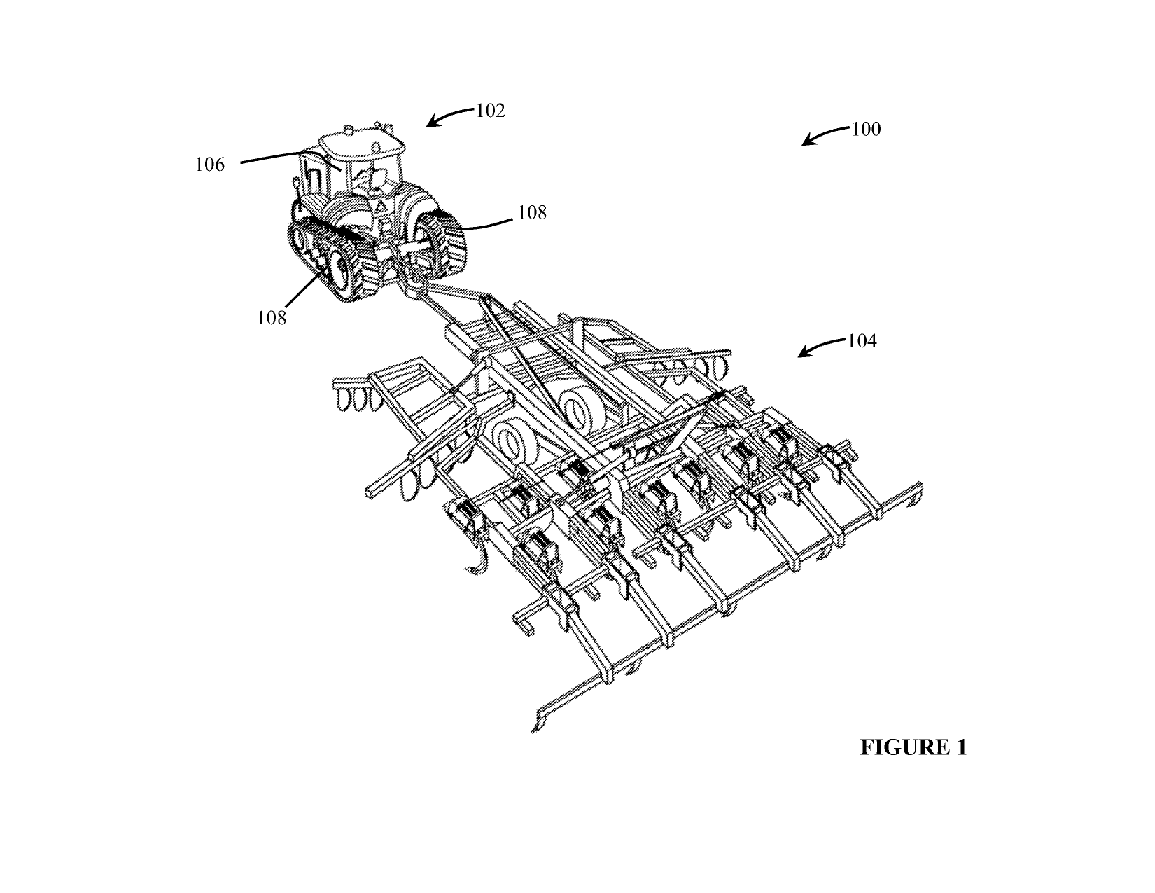

FIG. 1 illustrates a representative agricultural machine 100 having an agricultural vehicle 102 that has, or is otherwise coupled to, an agricultural implement or tool 104. In the illustrated embodiment, the agricultural implement 104 is configured for attachment to a hitch, drawbar, or other suitable implement attachment interface of the agricultural vehicle 102. The agricultural vehicle 102 can therefore be configured to tow, pull, or otherwise drive movement of the agricultural implement 104 in at least connection with the agricultural implement 104 performing an agricultural or construction operation. However, according to certain embodiments, the agricultural implement 104 can be part of, or integrated into the agricultural vehicle 102.

The agricultural implement 104 can be configured for interaction with an underlying surface (i.e., the ground) in use thereof. For example, with respect to the exemplary embodiment shown in FIG. 1, the illustrated agricultural implement 104 is embodied as, or otherwise includes tillage equipment. In some embodiments, the illustrative agricultural implement 104 may be embodied as, or otherwise include, any one of a number of tillage devices. However, it should be appreciated that the agricultural implement 104 may be embodied as, or otherwise include, any other suitable type of tool, including, for example, a tool used to at least engage a ground surface or a crop material, as well as be any other type of agricultural or construction implement 104 that can be utilized to perform an agricultural or construction operations. For example, in some embodiments, the agricultural implement 104 can be a ground contact implement that is embodied as a seeder or planter device. Additionally, the agricultural implement 104 can be embodied as, included in, or otherwise adapted for use with, equipment used in lawn and garden, construction, landscaping and ground care, golf and sports turf, forestry, engine and drivetrain, or government and military applications, among other applications.

The agricultural implement 104 of the present disclosure may be included in, or otherwise adapted for use with, a variety of different types of agricultural vehicles 102, including, for example, tractors, front end loaders, scraper systems, cutters and shredders, hay and forage equipment, planting equipment, seeding equipment, sprayers and applicators, utility vehicles, mowers, dump trucks, backhoes, track loaders, crawler loaders, dozers, excavators, motor graders, skid steers, tractor loaders, wheel loaders, rakes, aerators, skidders, bunchers, forwarders, harvesters, swing machines, knuckleboom loaders, diesel engines, axles, planetary gear drives, pump drives, transmissions, generators, or marine engines, among other suitable equipment.

The agricultural vehicle 102 may, or may not, be an autonomous or semi-autonomous vehicle. According to the illustrated embodiment, the agricultural vehicle 102 can include an operator cab 106 at which an operator can be positioned within the agricultural vehicle 102 in connection with the operator operating, including, for example, controlling the movement, direction of travel, and/or speed of travel, of the agricultural vehicle 102, and thus of the agricultural machine 100. The agricultural vehicle 102 can further include a plurality of ground engagement bodies 108, including, for example, a plurality of wheels, tires, or tracks, as well as combinations thereof, that can engage the adjacent ground surface and be utilized in the propulsion and/or steering of the agricultural vehicle 102.

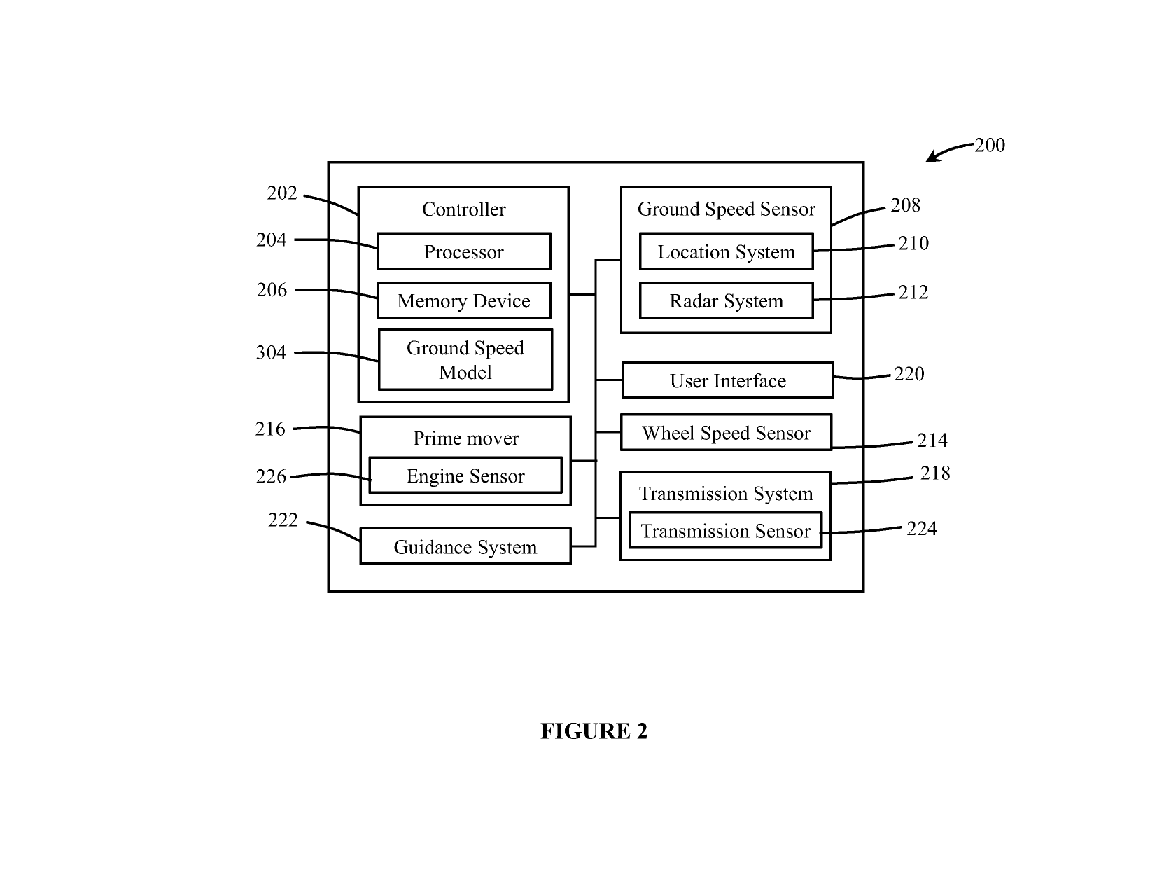

FIG. 2 illustrates a simplified block diagram of an exemplary ground speed control system 200 for controlling the ground travel speed and wheel speed of the agricultural machine 100, which can include the agricultural vehicle 102 with, or without, the implement 104. As illustrated, the ground speed control system 200 can include one or more controllers 202 having one or more processors 204 and one or more memory devices 206. The processors 204 can be configured to follow instructions, including control instructions contained with, or are part of, one or more of the memory devices 206, including, for example, a non-transitory machine-readable medium.

The processors 204 can be embodied as any type of processor or other compute circuit capable of performing various tasks. In some embodiments, each processor 204 can be embodied as a single or multi-core processor, a microcontroller, or other processing or controlling circuit. Additionally, in some embodiments, each processor 204 can be embodied as, include, or be coupled to an FPGA, an application specific integrated circuit (ASIC), reconfigurable hardware or hardware circuitry, or other specialized hardware to facilitate performance of the functions described herein. In some embodiments still, each processor 204 can be embodied as a high-power processor, an accelerator co-processor, an FPGA, or a storage controller.

The memory device 206 may be of one or more types of non-transitory computer-readable media, such as a solid-state memory, electromagnetic memory, optical memory, or a combination thereof. Further, the memory device 206 may be volatile and/or nonvolatile. It should be appreciated that the memory device 206 may store data that is manipulated by the operating logic of processor 204, such as, for example, data representative of inputted signals in addition to or in lieu of storing programming instructions defining operating logic. Each memory device 206 can store various software and data used during operation of the system 200, such as applications, programs, libraries, and drivers. Thus, the memory devices 206 can include information, including, but not limited to, algorithms and look-up tables, among other information, that can used by the processor 204, including with respect to features corresponding adjustments to a wheel speed of one or more ground engagement bodies 108 of the agricultural vehicle 102, as discussed below.

The ground speed control system 200 can include one or more ground speed sensors 208 that can provide information regarding a speed of travel, or ground travel speed, of the agricultural vehicle 102, and thus the agricultural machine 100. According to certain embodiments, the ground speed sensor 208 can be, or include, a location system 210, such as, for example, a global navigation satellite system, including, but not limited to, a global positioning system (GPS), that can provide information to determine an actual ground travel speed of the agricultural vehicle 102 and/or agricultural machine 100. The location system 210 can be operated to provide a detailed indication of the location of the agricultural vehicle 102 as the agricultural machine 100 traverses across the field. According to certain embodiments, the location system 210 can include a receiver that can receive information from an external source that can indicate particular locations, such as, for example, via location coordinates, at different times or at certain time intervals. Changes in the identified locations of the agricultural vehicle 102, and thus the agricultural machine 100, can be used, such as, for example, by the controller 202 to determine a distance traveled, or not traveled, by the agricultural vehicle 102 and/or agricultural machine 100. Further, information regarding the times at which the different locations were identified, or the lapse in time between the agricultural vehicle 102 and/or agricultural machine 100 reaching different identified locations, as well as the distances between such locations, can be used by the controller 202 to determine an actual speed of travel, or ground travel speed, being attained by the agricultural vehicle 102 and/or agricultural machine 100. However, the ground travel speed of the agricultural vehicle 102 and/or agricultural machine 100 can be determined in a variety of different manners, including, for example, via information provided by a radar system 212.

The ground speed control system 200 can further include a wheel speed sensor 214 that can provide information indicative of a speed of rotation of a ground engagement body(ies) 108, also referred to herein as a wheel speed. For example, the according to certain embodiments, the wheel speed sensor 214 can be a wheel speed encoder or pulse counter that is positioned to measure a speed (e.g., revolutions per minute) that an axle that is couple to a ground engagement body 108 (e.g., wheel) is being rotated via power generated by a prime mover 216 of the agricultural vehicle 102 and transmitted via at least a transmission system 218 of the agricultural vehicle 102 to the axle. If dimensional information is know regarding at least the axle, such as, for example, a rolling circumference of the axle, then such sensed speed information and the known dimensional information can be used to determine the wheel speed at which the engagement body 108 (e.g., wheel) is rotating. However, as previously mentioned, at least certain dynamics, including, for example, field dynamics, can cause, or contributed to, wheel slip. Thus, due to at least such wheel slip, the measured or sensed wheel speed of the ground engagement body(ies) 108 may not actually correspond to, or provide an accurate representation of, the actual ground travel speed of the agricultural vehicle 102. For example, due to wheel slip, the wheel speed may indicate the agricultural vehicle 102, and thus, the agricultural machine 100 is traveling at a speed that is higher than the ground travel speed that the agricultural vehicle 102 is actually traveling.

The ground speed control system 200 can further include a user interface 220 which can be located at the agricultural vehicle 102, such as, for example, in the operator cab 106, or can be a remotely located or mobile interface, such as, for example, part of a smart phone, tablet, laptop, or other computing device. The user interface 220 can take a variety of different forms, including, for example, a touch screen, keyboard, keypad, mouse, switch, joystick, or button, as well as any combinations thereof, among other types of user interfaces or input/output devices. As discussed below, according to at least certain embodiments, the user interface 220 can used by an operator to input a selected, or pre-selected, ground travel speed for the agricultural vehicle 102 and/or agricultural machine 100.

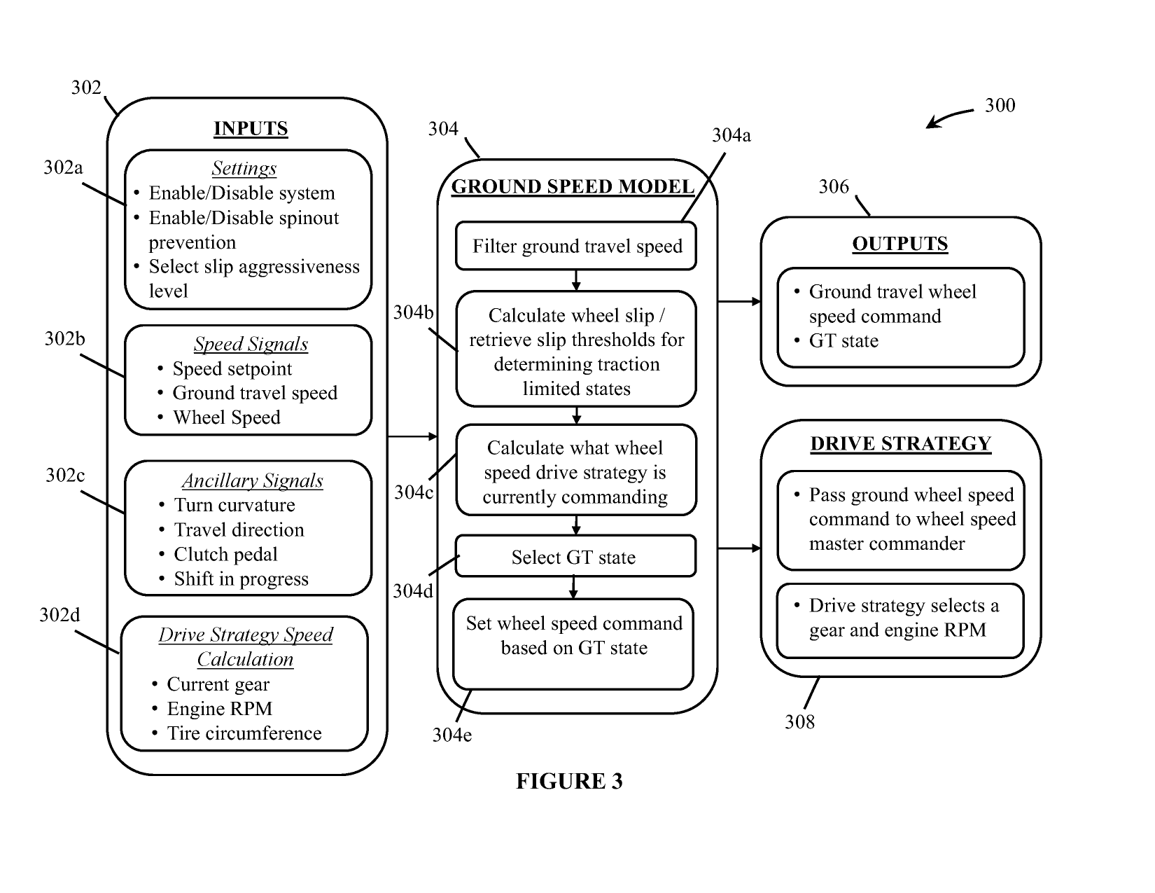

FIG. 3 illustrates a simplified exemplary representation of a method 300 involving control logic for a ground speed control system 200 in connection with controlling a ground travel speed and wheel speed for an agricultural vehicle 102, and thus for an agricultural machine 100. The method 300 corresponds to, or is otherwise associated with, performance of the illustrative sequence shown in, and described in connection with, FIG. 3, and can be carried out, for example, by the exemplary ground speed control system 200 shown in FIG. 2, including, for example, one or more of the processors 204 using at least information stored on one or more memory devices 206. It should be appreciated, however, that the method 300 can be performed in one or more sequences different from the illustrative sequence. Additionally, the control logic mentioned below can include steps or processes other than, or in addition to, those discussed below.

As indicated by FIG. 3, a plurality of inputs 302 can be obtained, including measured, sensed, derived and/or received via a command or signal, among other type of inputs, that can be provided to a ground speed algorithm or model 304. As generally indicated by FIG. 2, the ground speed model 304 may be part of, or otherwise by used or accessed by, one or more of the one or more controllers 202.

As seen in FIG. 3, the inputs 302 can include one or more first settings or category of settings, such as, for example, one or more ground speed control settings 302a. According to certain embodiments, the ground speed control settings 302a can include settings that may be inputted by an operator of the agricultural vehicle 102 and/or the agricultural machine 100, including, for example, inputted by the operator via use of the user interface 220. As shown in FIG. 3, the ground speed control settings 302a can include an input indicating whether the ground speed control system 200 is to be enabled or disabled, including, for example, turned on/activated or turned off/deactivated.

If the ground speed control system 200 is enabled, the ground speed control system 200 can manipulate the wheel speed to at least attempt to attain an actual speed of ground travel for the agricultural vehicle 102 and/or agricultural machine 100 that is at, or around, a desired or selected speed setpoint, which may, for example, be set by the operator. For example, as discussed below, the selected or inputted speed setpoint, as well as other information, can be used by a controller 202 to determine a corresponding wheel speed command or signal for one or more of the ground engagement bodies. The wheel speed command can, when ground speed control system 200 is enabled, and in the presence of certain circumstances, be modified in manner that can compensate for certain dynamics that can, for example, relate to wheel slip and/or an underpowering of the agricultural vehicle 102 for a current operation or associated agricultural vehicle 102 and/or implement 104 configuration.

Whether the ground speed control system 200 can be enabled can be based on satisfaction of one or more criteria. For example, according to certain embodiments, whether the ground speed control system 200 can be enabled can be based on a status or setting of the transmission system 218 including, for example, whether the transmission setting 218 is currently being operated in a manual mode or in one or more automatic modes, including, for example, a full automatic mode or a custom automatic mode. In the manual mode, the operator may be manually controlling the timing of shifting transmission gear or ratio of the transmission system 218, as well as manually selecting transmission gear or ratio, during the operation of the agricultural vehicle 102. With respect to the fully automatic mode, one or more of the controllers 202 can be determining when to shift transmission gear or ratio of the transmission system 218, as well as select which transmission gear or ratio is to be currently used given the current operation of the agricultural vehicle 102, including with respect to the operation of the prime mover 216, including the revolutions per minute (RPM) of the prime mover 216. With respect to a custom automatic mode, and operator may preset one or more aspects regarding the operation of the transmission system 218, including, for example, identify which transmission gear or ratio the transmission system is to operate at part and a particular RPM of the prime mover 216.

The ground speed control settings 302a can also include, among other inputs, a signal indicating, if the ground speed control system 200 is enabled, whether features of the ground speed control system 200 regarding spinout prevention is enabled or disabled. Such spinout prevention features can generally relate to prevention of, or minimizing, spinout of one or more of the ground engagement bodies 108 relative to an adjacent ground surface. The spinout prevention feature of the ground speed control system 200 can be configured to, when enabled, reduce wheel speed when the wheel slip of one or more of the ground engagement bodies 108 has/have reached certain predetermined spinout slip thresholds, and/or in connection with the agricultural vehicle 102 losing momentum with respect to one or more directions of travel, including for example, with respect to travel in a generally forward direction of travel. As discussed below, the spinout prevention feature can be configured for the ground speed control system 200 to adjust the wheel speed command in a manner that attempts to regain traction of one or more of the of the ground engagement bodies 108 with the adjacent ground surface. Further, the spinout prevention feature can be configured to seek to prevent a ground engagement body(ies) 108 from digging itself into a hole in the adjacent ground surface. Accordingly, when the spinout prevention feature is enabled, if the wheel slip exceeds a predetermined spinout slip threshold, such as, for example, a predetermined threshold associated with a relatively exceedingly high level of wheel slip, the ground speed control system 200 can reduce the wheel speed, and continue to reduce the wheel speed until the wheel slip is reduced, and may maintain, a lower predetermined threshold or level of wheel slip.

Conversely, when the spinout prevention feature is disabled, the ground speed control system 200 may not adjust the wheel speed command despite the wheel slip satisfying, including exceeding, the predetermined spinout slip threshold. Thus, even if the agricultural vehicle 102 and/or agricultural machine 100 is in a stuck condition (e.g., a condition at which movement of the agricultural vehicle 102 is halted in at least one direction despite driven rotation of an engagement body 108), ground speed control system 200 may not seek to take actions to prevent further spinout of the ground engagement body(ies) 108 and any associated digging of the ground engagement body(ies) 108 into the adjacent ground surface.

The ground speed control settings 302a can also include a selection by the operator of the above-discussed aggressiveness level, which can also be referred to as a slip aggressiveness level. Each aggressiveness level can correspond to a predetermined threshold for wheel slip. The different aggressiveness levels can each provide one or more predetermined thresholds that ground speed control system 200 can use to evaluate the wheel slip. Moreover, the selected aggressiveness level for the traction limited state can be used to define, when the ground speed control system 200 is enabled, the amount of wheel slip or overspeed in terms of the wheel speed that the ground speed control system 200 will allow in connection with maintaining, or seeking to attain, the speed setpoint in terms of the actual ground travel speed of the agricultural vehicle 102. Additionally, the predetermined thresholds may, or may not, at least partially vary as a function of ground travel speed of the agricultural vehicle 102.

The predetermined thresholds for wheel slip can vary for each aggressiveness level. Thus, according to certain embodiments, the predetermined thresholds can increase with an increase in aggressiveness level. For example, the predetermined threshold associated with a high slip aggressiveness level can be higher (e.g., accommodate more wheel slip, including on a percentage basis) than the predetermined thresholds associated with the medium and low slip aggressiveness levels. Similarly, the predetermined threshold associated with the low slip aggressiveness level can be lower than the predetermined thresholds associated with the medium and high slip aggressiveness levels. Additionally, each particular aggressiveness level can be based on a variety of considerations, including, for example, considerations relating to the agricultural machine 100, including type and/or configuration, the agricultural operation that is to be performed by the agricultural machine 100, and/or soil characteristics, among other considerations. For example, different types and/or configurations of the ground engagement bodies 108, including, for example, two track, four track, or wheels, can each differently interface with the adjacent ground, including soil. Thus, the predetermined thresholds for the different aggressiveness levels can vary for different types and/or configurations of ground engagement bodies 108.

Which particular aggressiveness level an operator may select can be based on a variety of criteria, including, for example, based on the particular operation the agricultural machine 100 is at least attempting to perform. For example, selection of an aggressiveness level can, for example, involve considerations relating to the extent a potential disturbance of the ground surface (e.g., tearing up of the ground surface) that may be caused by wheel slip is, or is not, a concern. For example, certain agricultural operations such as, for example, planting or passage along a grassy pasture, may seek to minimize wheel slip in an attempt to minimize the extent wheel slip by the ground engagement bodies 108 may disrupt or tear into the adjacent ground surface. Accordingly, for such operations, a low or medium level of aggressiveness level may be selected by the operator. However, such lower aggressiveness levels may, at least occasionally, when the ground speed control system 200 is at least attempting to reduce wheel speed so as to reduce wheel slip below the corresponding predetermined threshold, result in a slower speed of ground travel for the agricultural vehicle 102. Alternatively, the extent wheel slip by the ground engagement bodies 108 disrupts or tears into the adjacent ground surface for other operations, such as, for example, during tilling, may be of less significance. Thus, in such situations, a high level of aggressiveness may be selected. Thus, while such a higher aggressiveness may result in a higher level or wheel slip, and thus more tearing into the ground surface, such a higher aggressiveness level may minimize the extent the speed of ground travel for the agricultural vehicle 102 is slowed due to attempts by the ground speed control system 200 to reduce wheel slip by reducing wheel speed.

According to certain embodiments, a low slip aggressiveness level can provide a first predetermined threshold at which, if satisfied, the ground speed control system 200 may seek to adjust wheel speed so as to reduce wheel slip. In one non-limiting example, the low slip aggressiveness level can correspond to a first predetermined threshold that is based on a value, or range of values, for a slip velocity that can be the relative speed between a ground engagement body 108 (e.g., wheel) and the adjacent ground or ground travel speed. For example, the first predetermined value can be a slip velocity that is to not exceed 3 kilometers per hour (kph). In such an example, if the slip velocity is larger than 3 kph, then the ground speed control system 200 is configured to generate a signal to adjust a wheel speed command in attempt to have the wheel slip, as determined based on the slip velocity, return to being within, or below, the first predetermined threshold (e.g., not exceed 3 kph).

Similarly, the medium slip aggressiveness level can have a second predetermined threshold that is different than the first predetermined threshold. For example, the medium slip aggressiveness level can have a second predetermined threshold, which in this example, can be based on slip velocity, for which the slip velocity is to not exceed around 5 kph. Thus, compared to the first predetermined threshold being a slip velocity that is not to exceed 3 kph, when operating using the medium slip aggressiveness level, the ground speed control system 200 can tolerate a higher level of wheel slip (e.g., wheel slip corresponding to a slip velocity that is not to exceed 5 kph) than the level of the first predetermined threshold of the low slip aggressiveness level.

In this example, with respect to the high slip aggressiveness level, the high slip aggressiveness level can have a third predetermined threshold (e.g., slip velocity that is not to exceed 7 kph) that is higher than both the first and second predetermined thresholds. Thus, while the high slip aggressiveness level can accommodate a higher level of the wheel slip in connection with operating the wheel speed at levels that can assist the ground travel speed of the agricultural vehicle 102 and/or agricultural machine 100 attaining the speed setpoint, the high slip aggressiveness level may, compared to the lower aggressiveness levels for the traction limited state, be more susceptible to spinout of the ground engagement body(ies) 108.

Additionally, when spinout prevention feature of the ground speed control system 200 is enabled, the predetermined threshold for the selected aggressiveness level can also be used to determine the spinout slip threshold. For example, the spinout slip threshold can be a predetermined amount or percentage above the predetermined threshold for each of the corresponding aggressiveness levels. The extent that the spinout slip threshold exceeds the predetermined threshold for each of the aggressiveness levels can be the same, or different, for each of the aggressiveness levels. Thus, for example, as the predetermined threshold for wheel slip for the low slip aggressiveness level is lower than the predetermined thresholds for wheel slip for the medium and high slip aggressiveness levels, the range of wheel slip beyond the predetermined threshold for the low slip aggressiveness level may be greater than a corresponding range for the spinout slip threshold beyond the predetermined thresholds for the medium and high slip aggressiveness levels, respectively.

The inputs 302 can further include a second setting or category of inputs, including, for example, one or more speed signal inputs 302b. The speed signal inputs 302b can include, for example, a speed setpoint that can correspond to a desired ground travel speed for the agricultural vehicle 102 and/or for the agricultural machine 100. As previously mentioned, according to certain embodiments, the speed setpoint can be inputted by an operator, including, for example, via use of the user interface 220.

The speed signal inputs 302b can further include information regarding the actual ground travel speed of the agricultural vehicle 102 and/or agricultural machine 100, including, for example, the actual ground travel speed as indicated by the ground speed sensor 208. As discussed above, according to certain embodiments, information from one or more of the location system 210 and/or radar system 212 can be used to determine the actual ground travel speed. According to certain embodiments, the ground speed control system 200 can toggle between using information from one of the location system 210 and radar system 212 to the other of the location system 210 and radar system 212. For instance, in certain open areas or fields, the ground speed control system 200 can use information from the location system 210 indicating, or used to determine, the actual ground travel speed, and toggle to using information from the radar system 212 in other areas, including covered or wooded areas, where obstacles may interfere with the location system 210, including a GPS system, receiving a signal used for location identification. As also mentioned above, due to at least certain dynamics, including field dynamics that can contribute to wheel slip, the speed setpoint can be different, including higher or faster, than the actual ground travel speed.

The speed signal inputs 302b can also include, among other information, information provided by the above-discussed wheel speed sensor 214 that indicates, or is otherwise used to determine, the wheel speed of one or more ground engagement bodies 108 (e.g., wheels), as discussed above.

The inputs 302 can further include a third set of settings or category of inputs, including, for example, one or more ancillary or general signal inputs 302c. According to certain embodiments, the ancillary signal inputs 302c can correspond to information or trigger events that can indicate whether the ground speed control system 200 is to, at least temporarily, be disabled. For example, during certain maneuvers of the agricultural machine 100, including when the agricultural vehicle 102 is performing a turn in a headland, or in view of the size of a turn curvature, the ground speed control system 200 can be temporarily disabled. Such movement, or upcoming movement, and the nature of the movement, including, for example, the size of a turn curvature, can be determined proactively and/or reactively in a variety of different manners, including, for example, from information provided by a guidance system 222 of the agricultural vehicle 102 and/or derived from information provided by the location system 210. Further, such guidance movement can, for example, be utilized to determine one or more of the time of when the ground speed control system 200 is to be disabled, the duration that the ground speed control system 200 is to be disabled, and/or the time when the maneuver is to be, or is anticipated to be, completed so as to identify when the ground speed control system 200 is to be re-enabled.

A variety of other detected trigger events can also be utilized to at least temporarily disable the ground speed control system 200. For instance, detection of an engagement of a clutch of the transmission system 218, as may be detected by at least a position sensor, or an occurrence of a shifting of a transmission gear or ratio of the transmission system 218, as may be indicated by information provided by a transmission sensor 224, can provide triggering events that at least temporarily disable the ground speed control system 200. Moreover, the ground speed control system 200 can be configured to at least temporarily and activate the ground speed control system 200 such that the ground speed control system 200 does not attempt to facilitate a change in the wheel speed while the transmission system 218 is undergoing a shift in transmission ratio. In such situations, the ground speed control system 200 can be re-enabled upon a detection of a release of the clutch, or a completion of the shifting of the transmission gear or ratio.

As also seen in FIG. 3, the ancillary signal inputs 302c can further include information regarding a direction of travel, or heading, of the agricultural vehicle 102 and/or the agricultural machine 100. For example, an enabled ground speed control system 200 can generally remain enabled as the agricultural vehicle 102 generally travels in at least a forward direction, as may be determined, for example, from information provided by the guidance system 222 and/or the location system 210. However, the ground speed control system 200 can be configured to disable the ground speed control system 200 at least temporarily upon detection that the agricultural vehicle 102 is generally traveling, or has a heading, in a reverse direction. Similarly, such directional information can, among other information, be used to determine a job status or operational mode of the agricultural machine 100, including whether the agricultural vehicle 102 is parked, and thus is not moving. In such situations, the ground speed control system 200 can be configured to at least temporarily be disabled based on the lack of movement of the agricultural machine 100 and/or an identified operational mode of the agricultural machine 100.

The inputs 302 can further include a fourth set of settings or category of inputs, including, for example, an input relating to a drive strategy speed calculation 302d. The drive strategy speed calculation 302d can be utilized in at least an attempt to calculate a desired wheel speed that is to be attained for one or more of the engagement bodies 108. According to certain embodiments, the desired wheel speed can be based on the speed setpoint that may be inputted, including selected, by the operator, as previously discussed. However, a variety of other factors can influence, or be used to adjust, the desired wheel speed, including, for example, the hand throttle position, and/or a degree of incline/decline of travel of the agricultural machine 100, among other factors. Thus, in at least certain situations, the drive strategy speed calculation 302d can provide information that can assist in determining the desired wheel speed. For example, as seen in FIG. 3, according to certain embodiments, the drive strategy speed calculation 302d can be determined using information relating to the current, or a desired, engaged transmission gear or ratio of the transmission system 218, as may be determined, for example, by information provided a transmission sensor 224 (FIG. 2). The drive strategy speed calculation 302d can also be determined, at least in part, using information relating to a current or desired speed (e.g., RPM) of the prime mover 216 and a size, such as, for example, circumference of an engagement body 108, including, for example, a wheel or tire circumference. However, the wheel speed can be calculated in a variety of other manners, including, for example, using information relating to the prime mover 218 load (e.g., engine load) at speed.

The inputs 302 can be communicated, or otherwise provided to, the ground speed control model 304. The ground speed control model 304, which again, can be part of, or otherwise utilized by, the controller 202, can be generally configured to manipulate, including adjust or modify, an outputted wheel speed command to at least attempt to have the actual ground travel speed of the agricultural vehicle 102 and/or agricultural machine 100 attain, or be consistent with, the speed setpoint that the operator has selected, as previously discussed.

According to the illustrated embodiment, the ground speed control model 304 can include, or perform, a filter 304a for filtering at least a portion of the information provided to the ground speed control model 304, including information provided to the ground speed control model 304 by one or more of the inputs 302. For example, according to certain embodiments, the filter 304a can be configured to filter noise from information, including signals, from one or more of the inputs 302, including, for example, with respect to one or more of the speed settings 302b, such as, for example, information from the ground speed sensor 208. Information can be filtered by the ground speed control model 304 in a variety of manners. For example, according to certain embodiments, the filter 304a can be configured to filter noise from actual ground travel speed information provided by, or derived from, the location system 210 and/or radar system 212 using a three-point moving average wherein an average of three determined actual ground travel speeds for the agricultural vehicle 102, including three consecutive ground travel speeds, are used to determine the actual ground travel speed of the agricultural vehicle 102 and/or agricultural machine 100.

As indicated by block 304b in FIG. 3, the filtered information attained via use of the filter 304a, along with information provided by the one or more speed signal inputs 302b, among other information, can be used by the ground speed control model 304 to determine, including calculate, information regarding at least the wheel slip being experienced by one or more of the ground engagement bodies 108. As previously discussed, such wheel slip can generally be the difference between what is the anticipated ground travel speed of the agricultural vehicle 102 and/or agricultural machine 100 based on a detected or determined wheel speed of one or more of the ground engagement bodies 108, and the actual ground travel speed of the agricultural vehicle 102 and/or agricultural machine 100, which again, can be determined using information provided by the ground speed sensor 208.

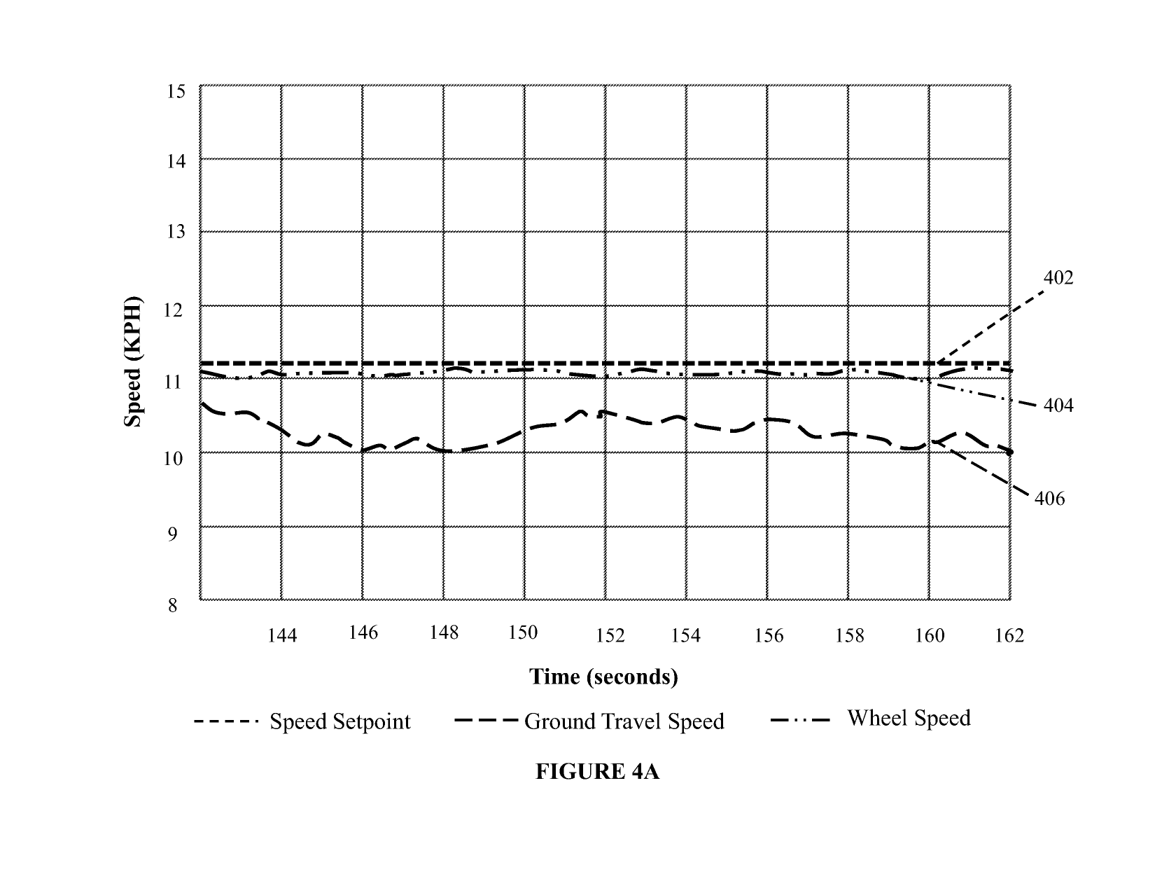

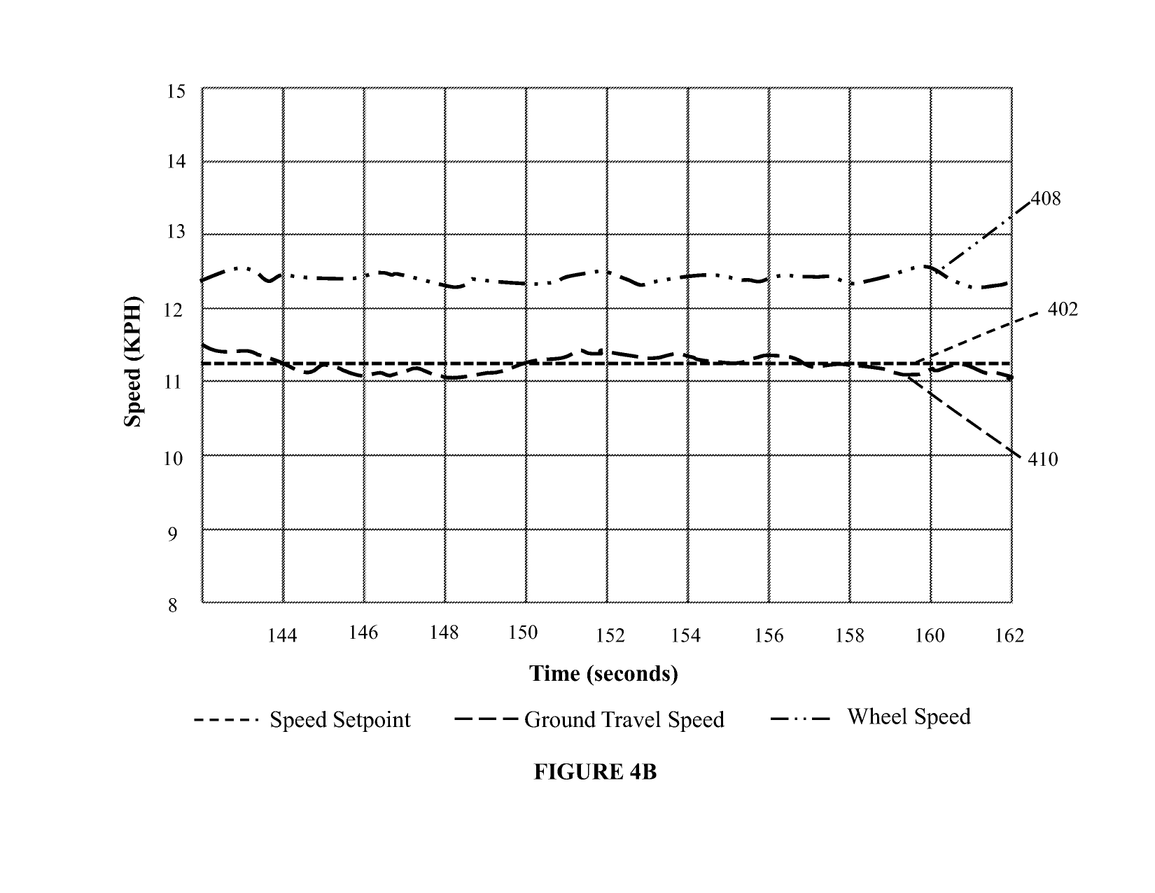

FIG. 4A illustrates an example of an influence of field dynamics on the actual ground travel speed not attaining a speed setpoint when the ground speed control system 200 is not enabled to adjust a corresponding engagement body speed. Again, an operator can select the speed setpoint, as indicated by line 402 in FIG. 4A, and which can, in this example, be included with the one or more speed signal inputs 302b provided to the ground speed control model 304. As seen by line 402 in the example depicted in FIG. 4A, in this non-limiting example, the operator has selected a speed setpoint that is slightly above 11 kilometers per hour (kph), which is consistent throughout the depicted time. Accordingly, the drive strategy speed calculation 302d provided to the ground speed control model 304 can determine a wheel speed for one or more of the engagement bodies 108 to attain the speed setpoint, which in this example, can correspond to a wheel speed of 11 kph. Further, as previously mentioned, the actual wheel speed can be determined using at least information provided by the wheel speed sensor 214, as previously discussed. In this example, the actual wheel speed, as shown in FIG. 4A by line 404, is maintained generally around the speed setpoint, and, more specifically, between 11 kph and the speed setpoint. However, as seen in FIG. 4A, the actual ground travel speed of the agricultural vehicle 102 and/or agricultural machine 100, as determined using information from the indicated ground speed sensor 208 (e.g., the location system 210 and/or radar system 212) is, as illustrated by line 406, below 11 kph, and, moreover, fluctuates between about 10 kph and about 11 kph. Thus, in this example, the wheel slip at times exceeds slightly above 1 kph, or is generally around 10% of the speed setpoint. In other words, the actual ground travel speed of the agricultural vehicle 102 and/or agricultural machine 100 is, at times, less than 90% of the actual wheel speed.

FIG. 4B illustrates the example scenario shown in FIG. 4A but wherein the ground speed control system 200 is enabled to modify the wheel speed so that the ground travel speed is in closer alignment with the speed setpoint. Again, as seen by line 402, in this example the speed setpoint is slightly above 11 kph, which is consistent throughout the depicted time. Accordingly, the drive strategy speed calculation 302d provided to the ground speed control model 304 can at least initially determine a wheel speed command for one or more of the engagement bodies 108 to attain the 11 kph speed setpoint. Yet, as discussed above with respect to the example provided in FIG. 4A, due to wheel slip, despite the wheel speed (line 404 in FIG. 4A) being around 11 kph, the actual ground travel speed (line 406 in FIG. 4A) may not attain the 11 kph speed setpoint. Thus, in the example shown in FIG. 4B, and as further discussed below, with the ground speed control system 200 enabled, the ground speed control system 200 can adjust a wheel speed command in a manner that attempts to have the actual ground speed travel (line 410 in FIG. 4B) be at or around the 11 kph speed setpoint (line 402 in FIG. 4B). Thus, in this example, the ground speed control system 200 can adjust the wheel speed command such that the wheel speed is around 12 kph to 13 kph, as shown by line 408 in FIG. 4B. Further, such a difference between the actual ground travel speed and the wheel speed can indicate the wheel slip is experiencing a slip velocity of between about 1 and 2 kph, which, at a ground travel speed of 11 kph may be, for the selected aggressiveness level, within a predetermined threshold for a normal operation state, as also discussed below.

Referencing FIG. 3, additionally, at block 304b, the associated predetermined thresholds for the slip aggressiveness levels for the traction limited state can also be determined, including retrieved from the memory device 206 based on the slip aggressiveness level inputted at block 302a. For example, as discussed above, according to certain embodiments, the plurality of slip aggressiveness levels can include, for example, a low slip aggressiveness level having a first predetermined threshold for wheel slip, a medium slip aggressiveness level having a second predetermined threshold for wheel slip, and a high body level having a third predetermined threshold for wheel slip, wherein each of the first, second, and third predetermined thresholds are different from each other. Such identification of the predetermined threshold associated with the selected slip aggressiveness level, as selected at block 302a, as well as the current wheel slip determined at block 304b can, at block 304b, be used to determine whether the current wheel slip is, or is not, within, the identified predetermined threshold.

When the ground speed control system 200 is not enabled, a wheel speed master controller can receive a wheel speed signal outputted by the controller 202 via use of one or more models that can identify a wheel speed that is to be attained based at least on an inputted, including selected, speed setpoint. Based on such a received wheel speed output command, the wheel speed master controller can determine one or more commands, including, for example, with respect to either or both the prime mover 216, including, for example, an RPM for the prime mover 216, and the transmission system 218, including a gear or ratio of the transmission system that is to be engaged, to attain the outputted wheel speed. Thus, with respect to the ground speed control model 304, as indicated by block 304c, according to certain embodiments, implementation of the ground speed control model 304 can include determining, including calculating, the wheel speed drive strategy currently being commanded. Moreover, such a determination by the ground speed control model 304 of the current wheel speed drive strategy being implemented can be based on a variety of different types of information, including, for example, based on a speed of the prime mover 216 (e.g., engine speed) and the currently engaged transmission gear or ratio of the transmission system 218, among other metrics, currently being requested by, for example, the wheel speed master controller.

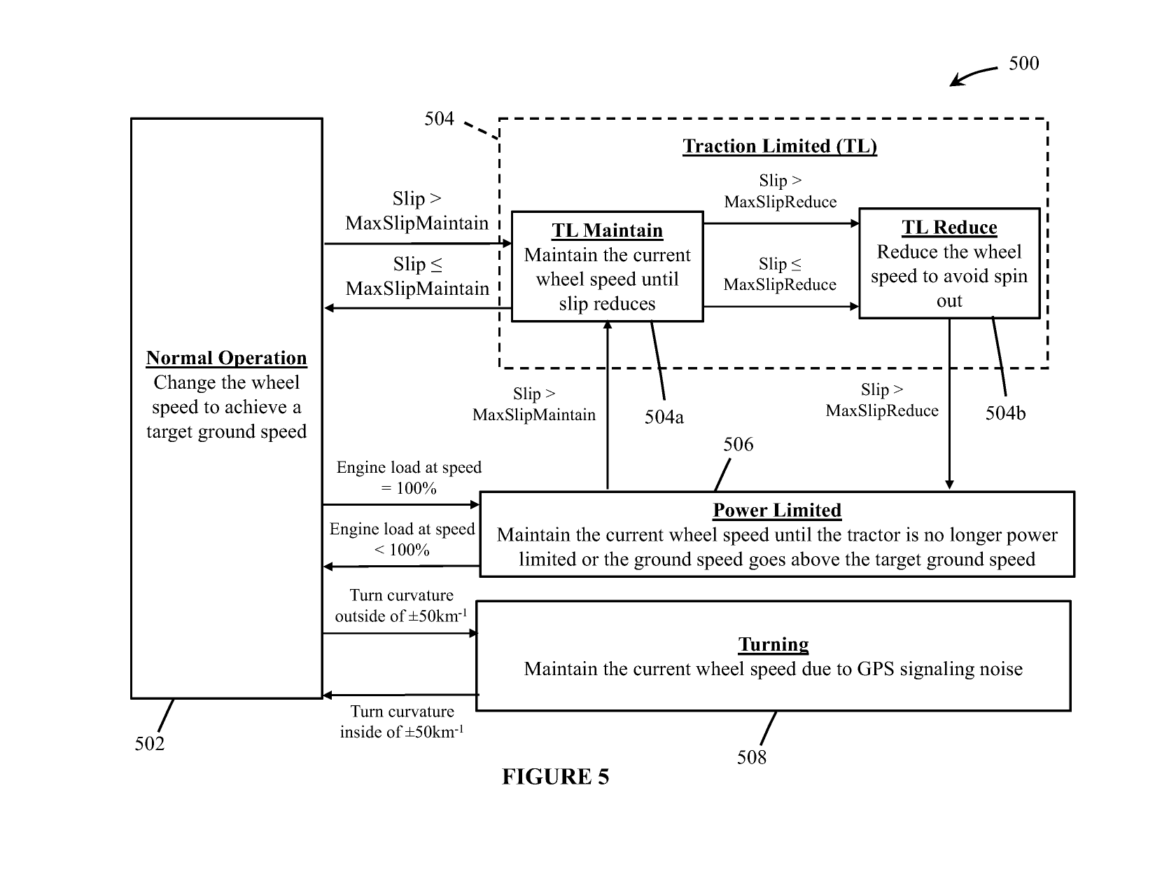

At block 304d, the ground speed control model 304 can select a ground travel (GT) state from a plurality of ground travel states for use by the ground speed control model 304, each ground travel state providing a different strategy(ies) for management of either or both the wheel speed and the actual ground travel speed of the agricultural vehicle 102. For example, as indicated by at least the ground travel state chart 500 shown in FIG. 5, the ground speed control model 304 can, according to certain embodiments, select from one or more, if not all, of the following operational ground travel states: a normal operation state 502; a traction limited (TL) state 504 that can include one or more of a traction limited maintain state 504a and a traction limited reduced state 504b; a power limited state 506; and, a turning state 508, among other ground travel states.

As generally indicated by FIG. 5, the normal operation state 502 can be configured to provide a wheel speed strategy and/or ground travel speed strategy in which the ground speed control model 304 can adjust a wheel speed command to change the wheel speed, such as, for example, changing the wheel speed setting, in a manner that can achieve, or come closed to, a target ground travel speed (e.g., the speed setpoint) for the agricultural vehicle 102. When operating in the normal operation state 502, information inputted to the ground speed control model 304 can be used by the ground speed control model 304 to determine that the agricultural vehicle 102 is currently operating in a manner in which a range, or extent, of wheel slip being experienced by the ground engagement bodies 108 is within acceptable limits, and that the agricultural vehicle 102 has sufficient power to operate under the current, or desired, speed of the agricultural vehicle 102. Thus, in the normal operation state 502, the ground speed control model 304 can attempt to operate, or provide commands to adjust, the wheel speed of one or more of the ground engagement bodies 108 in at least an attempt to have the agricultural vehicle 102 and/or agricultural machine 100 attain the speed setpoint. According to certain embodiments, at least the normal operation state 502 can involve a proportional and derivative (PD) control loop that is based on the current, or desired, ground travel speed of the agricultural vehicle 102.

While operating in at least the normal operation state 502, in the event the detected wheel slip, as may be calculated at block 304b, rises to, or exceeds, the predetermined threshold associated with the selected slip aggressiveness level inputted at block 302a, the ground speed control model 304 can change from the normal operation state 502, and instead enter into the traction limited state 504. For example, in response to detection of the wheel slip exceeding the predetermined threshold associated with one of the above-discussed low, medium, or high slip aggressiveness levels (as generally indicated by “Slip > MaxSlipMaintain” in FIG. 5), the ground speed control model 304 can enter the traction limited state 504. Further, in the event the detected wheel slip subsequently is reduced to being below the predetermined threshold for the selected aggressiveness level (as generally indicated by “Slip ≤ MaxSlipMaintain” in FIG. 5), the ground speed control model 304 can change from operating in the traction limited state 504, and instead enter, for example, into the normal operation state 502.

In the event the spinout prevent features of the ground speed control system 200 are enabled, when entering into the traction limited state 504, and/or while in the traction limited state 504, the ground speed control model 304 can enter into, or switch between, a traction limited state 504a and/or a traction limited reduced state 504b. Alternatively, in the event the spinout prevent features of the ground speed control system 200 are disabled, the ground speed control system 200 can, when the traction limited state 504, be in the traction limited state 504a.

For example, at least when slip prevention features are disabled, in response to detection of the wheel slip exceeding the predetermined threshold (“MaxSlipMaintain”) associated with one of the above-discussed low, medium, or high slip aggressiveness levels (as generally indicated by “Slip > MaxSlipMaintain” in FIG. 5) the ground speed control model 304 can enter the traction limited maintain state 504a. When operating in the traction limited maintain state 504a, the ground speed control model 304 can be configured to provide a strategy for managing wheel speed, including maintaining a current wheel speed setting, in which the ground speed control model 304 at least attempts to hold, or maintain, a previous wheel speed command. Thus, the wheel speed command outputted from the ground speed control model 304 when the ground speed control model 304 is in the traction limited maintain state 504a may not seek to increase wheel speed, including a wheel speed setting, so as to at least attempt to not increase or induce more wheel slip of the ground engagement bodies 108. Thus, in such a situation, the ground speed control model 304 may not modify, or adjust, a wheel speed command that is to be delivered to the wheel speed master controller. When spinout prevention features of the ground speed control system 200 are enabled, the ground speed control model 304 can still enter into the traction limited maintain state 504a if the detected wheel slip exceeds the predetermined threshold for the selected slip aggressiveness level but is below predetermined spinout slip threshold.

When spinout prevention features of the ground speed control system 200 is enabled, such as, for example, selectively enabled by an operator of the agricultural vehicle 102, the traction limited reduced state 504b can be utilized in connection with the ground speed control system 200 providing spinout prevent features. Moreover, the traction limited state 504b can be utilized to reduce detected wheel slip below at least the predetermined spinout slip threshold (“MaxSlipReduce”). Thus, in certain situations, if the detected wheel slip exceeds not only the predetermined threshold for the slip aggressiveness level, but also the higher predetermined spinout slip threshold (as generally indicated by “Slip > MaxSlipReduce” in FIG. 5), the ground speed control model 304 can operate in the traction limited state 504b.

By the detected wheel slip exceeding the higher predetermined spinout slip threshold (“MaxSlipReduce”), the agricultural machine 102, and, moreover, the ground engagement bodies 108, can be at least at risk of losing traction entirely, as well as further damage or disrupt the adjacent ground surface. Thus, when in the traction limited reduced state 504b, the ground speed control model 304 may modify the outputted wheel speed command to reduce the wheel speed, such as, for example, by reducing a wheel speed setting, such that the detected amount of wheel slip is can eventually fall below at least the predetermined spinout slip threshold (as generally indicated in FIG. 5 by “Slip ≤ MaxSlipMaintain”.)

The ground speed control model 304 can also be configured to limit whether, or when, the ground speed control model 304 can adjust the outputted wheel speed command to increase wheel speed, including, for example, a wheel speed setting while the ground speed control model 304 is operating in the normal operation state 502. For example, the ground speed control system 200 may monitor the engine load at speed of the prime mover 216 using, for example, information provided by the engine sensor 226 (FIG. 2), as discussed above. In certain situations, the ground speed control system 200 may determine that the engine load at speed is operating at a predetermined level, such as, for example, at 100% of full load (as generally indicated by “Engine load at speed = 100%” in FIG. 5). In such situations, the ground speed control model 304 can change, such as, for example, from being in the normal operation state 502, to a power limited state 506. When operating in the power limited state 506, given that the engine load at speed may be indicating that the prime mover 216 is at least currently underpowered, the ground speed control model 304 will not attempt to increase the wheel speed. Thus, when in the power limited state 506, even if the determined ground travel speed of the agricultural vehicle 102 is below the speed setpoint, because of the current engine load, the ground speed control model 304 will not seek to increase the wheel speed.

As also seen in FIG. 5, while operating in the power limited state 506, in some instances, the detected wheel slip may be determined by the ground speed control system 200 to exceed the predetermined threshold for the selected slip aggressiveness level (e.g., “Slip > MaxSlipMaintain”). In such a situation, the ground speed control model 304 can enter into the traction limited state 504. Whether the ground speed control model 304 enters into, the traction limited maintain state 504a before switching into the traction limited reduced state 504b can depend on whether the spinout prevention features are enabled and the extent of the detected wheel slip, as discussed above.

When the ground speed control model 304 operates in the power limited state 506, the ground speed control model 304 can return to the normal operation state 502 upon the ground speed control system 200, including the ground speed control model 304, determining that the engine load is at a level that is less than the predetermined engine load threshold, such as, for example, less than 100% of a full load (as generally indicated by “Engine load at speed < 100%” in FIG. 5), and the wheel slip, if any, does not exceed the predetermined threshold for the selected slip aggressiveness level.

The ground speed control model 304 can also enter an operational state based on a current travel, or direction of travel, of the agricultural vehicle 102, as well as a current state of operation of one or more components of the agricultural vehicle 102, including, for example, the transmission system 218. For example, as discussed above with respect to the auxiliary signal inputs 302c, according to certain embodiments, the ground speed control system 200 can monitor information provided by the guidance system 222 or other navigation system to determine if the agricultural vehicle 102 is, or is about to, engage in a turn, including, for example, in a turn in a headland area. Additionally, or alternatively, the ground speed control model 304 can receive information from one or more sensors, including, for example, sensors that may indicate, among other information, a positioning of a steering wheel and/or one or more of the engagement bodies 108 of the agricultural vehicle 102 that can indicate whether the agricultural vehicle 102 is, or is not, engaged in a turn. In such a situation, the direction of travel or heading of the agricultural vehicle 102 can be used by the ground speed control model 304 to determine that the ground speed control model 304 is, at least temporarily, to not make a change in the current wheel speed, such as, for example, not change a current wheel speed setting, and/or is to maintain a current wheel speed.

Additional criteria maybe utilized to determine whether the ground speed control model 304 should, or should not, make any adjustments in the wheel speed in connection with the agricultural vehicle 102 making a turn. For example, according to certain embodiments, whether the ground speed control model 304 is to enter into the turning state 508 can be determined based on a determination by the ground speed control model 304, or other portion of the ground speed control system 200, determining that the turn being, or will be, executed by the agricultural vehicle 102 is outside of a certain predetermined turn curvature or radius, including, for example, a turn curvature of 50 1/kilometer (50 km⁻¹) (as generally indicated in FIG. 5 by “Turn curvature outside of ±50km⁻¹”). In such a situation the ground speed control model 304 can operate in the turning state 508, and thus seek to maintain the current wheel speed, including the associated wheel speed setting, while the agricultural vehicle 102 is conducting the turn. Conversely, in such an embodiment, in the event the ground speed control system 200 determined the turn is inside of the predetermined turn curvature (as generally indicated in FIG. 5 by “Turn curvature inside of ±50km⁻¹”), the ground speed control model 304 can operate in another operating state, such as, for example, the normal operation state 502.

Alternatively, according to certain embodiments, the ground speed control model 304 can monitor other operational states, as indicated using at least information provided by the auxiliary signal inputs 302c, to determine whether to at least temporarily prevent the ground speed control model 304 from adjusting the wheel speed, including adjusting the outputted wheel speed command. For example, as previously discussed, the ground speed control system 200 may at least temporarily disable the ground speed control system 200 from being able to adjust the wheel speed in response to the ground speed control system 200 determining the that the transmission system 218 is changing gear or ratio, the clutch is engaged, the agricultural vehicle 102 is parked, the agricultural vehicle 102 is moving in a reverse direction, a throttle position, and/or a brake is at least partially engaged, among other operational states, positions, or statuses.

Using information provided by the inputs from block 302, including the speed setpoint, the actual ground travel speed (block 304a), the determined wheel slip and predetermined threshold for the selected aggressiveness for the traction limited state (block 304b), the identified wheel speed drive strategy currently being implanted (block 304c), the predetermined spinout slip threshold (if spinout features are enabled), and the selected ground travel (GT) state (block 304d), the ground speed control model 304 can be used to determine at block 304e a model wheel speed command, which may, or may not, modify the current wheel speed command.

The model wheel speed command can then be outputted by the ground speed control model 304 at block 306. Additionally, at block 306, the ground speed control model 304 can output a status of the ground speed control system 200, including, for example, an indication that the ground speed control system 200 is disabled, enabled and active, or enabled and ready. According to certain embodiments, an enabled and ready status for the ground speed control system 200 can correspond to active use of the ground speed control system 200 being at least temporarily disabled, such as, for example, while the agricultural vehicle 102 is performing certain tasks or maneuvers. For example, according to certain embodiments, while remaining enabled, the ground speed control system 200 may at least be temporarily suspended as the agricultural vehicle 102 is being moved into position to be coupled to the implement 104. Thus, in such situations, rather than disabling the ground speed control system 200, the ground speed control system 200 can instead enter an enabled and ready status.

According to certain embodiments, the status of the ground speed control system 200 outputted at block 306 can include a communication of the current ground travel state of the ground speed control system 200 to the operator of the agricultural vehicle 102. For example, according to certain embodiments, at block 306, the current ground travel state of the ground speed control system 200 can be communicated via use of the user interface 220, including, for example, displayed on a display or monitor within the operator cab 106 of the agricultural vehicle 102, among user interfaces 220 located at other locations. Additionally, the ground speed control system 200 can be adapted to, with respect to at least certain ground travel states, provide an indication to the operator that a change in an operation or configuration, including a setting(s), of the agricultural vehicle 102 and/or implement 104 may be warranted. For example, according to certain embodiments, upon, or within a predetermined time period of, the ground speed control system 200 entering into the power limited state 506, or in response to the ground speed control system 200 entering into the power limited state 506 a predetermined number of times within the predetermined time period, the ground speed control system 200 can provide an indication to the operator, such as, for example, via one or more signals communicated to the user interface 220, that a change in the configuration of at least the implement 104 may be warranted in view of the agricultural machine 100 operating, or repeatedly operating, in a manner in which the agricultural vehicle 102 is underpowered. Such an indication may be used to facilitate, for example, the operator changing a configuration, such as, for example, raising a depth at which at least a portion of the implement 104 is extending into the ground surface so as to reduce the power requirements currently being sought from the agricultural vehicle 102.

Additionally, as also seen in FIG. 3, at block 308, the model wheel speed command can be passed to the wheel speed master controller. Moreover, as seen for example in FIG. 5, with the ground speed control model 304 enabled, the ground speed control model 304 may receive, and possibly modify, as discussed above with respect to at least FIG. 3, the outputted wheel speed command such that the ground speed control model 304 outputs a model wheel speed command that is communicated to the wheel speed master controller. For example, as discussed above, when the ground speed control model 304 is operating in the TL maintain state 504a, power limited state 506, or the turning state 508, among other states, the model wheel speed command to the wheel speed master controller, if any, may seek to maintain, or not modify, the current wheel speed command and/or the current wheel speed command that is being implemented. However, when the ground speed control model 304 is operating in the normal operation state 502 or the TL reduced state 504b, the model wheel speed command to the wheel speed master controller may seek to adjust the wheel speed, including the wheel speed setting, to change the wheel speed to, respectively, either at least attempt to have the actual ground travel speed be at, or around, the speed setpoint, or reduce the wheel slip to a level below the spinout slip threshold, as discussed above.

The wheel speed master controller may then use at least the model wheel speed command to determine a drive strategy. For example, using the model wheel speed command, the wheel speed master controller can determine a transmission gear or ratio that the transmission system 218 is to use, and an engine speed for the prime mover 216 is to attain, in connection with satisfying the model wheel speed command. Thus, when the ground speed control system 200 is operating in the normal operation state 502 and the model wheel speed command seeks to increase the wheel speed, in connection with determining the determine a drive strategy, the wheel speed master controller may determine what transmission gear or ratio is to be engaged, and/or the engine speed for the prime mover 216.

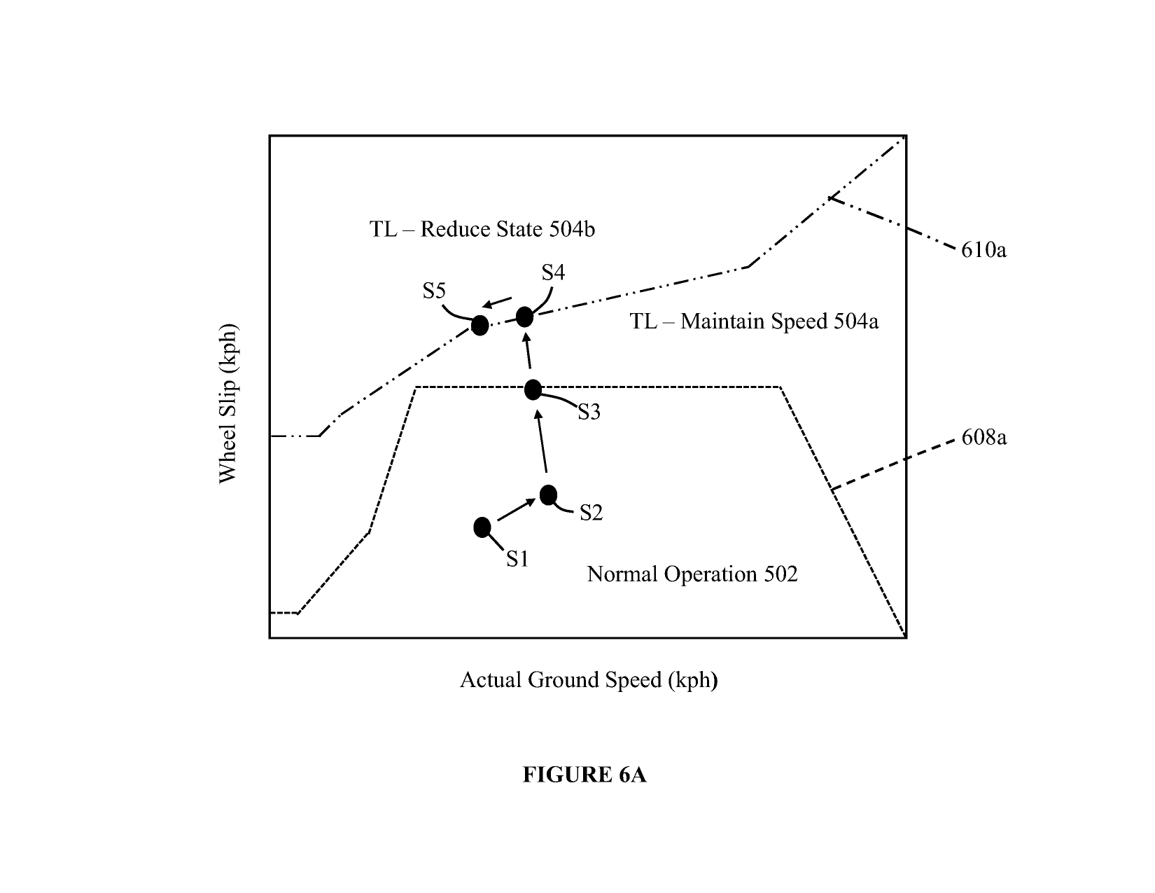

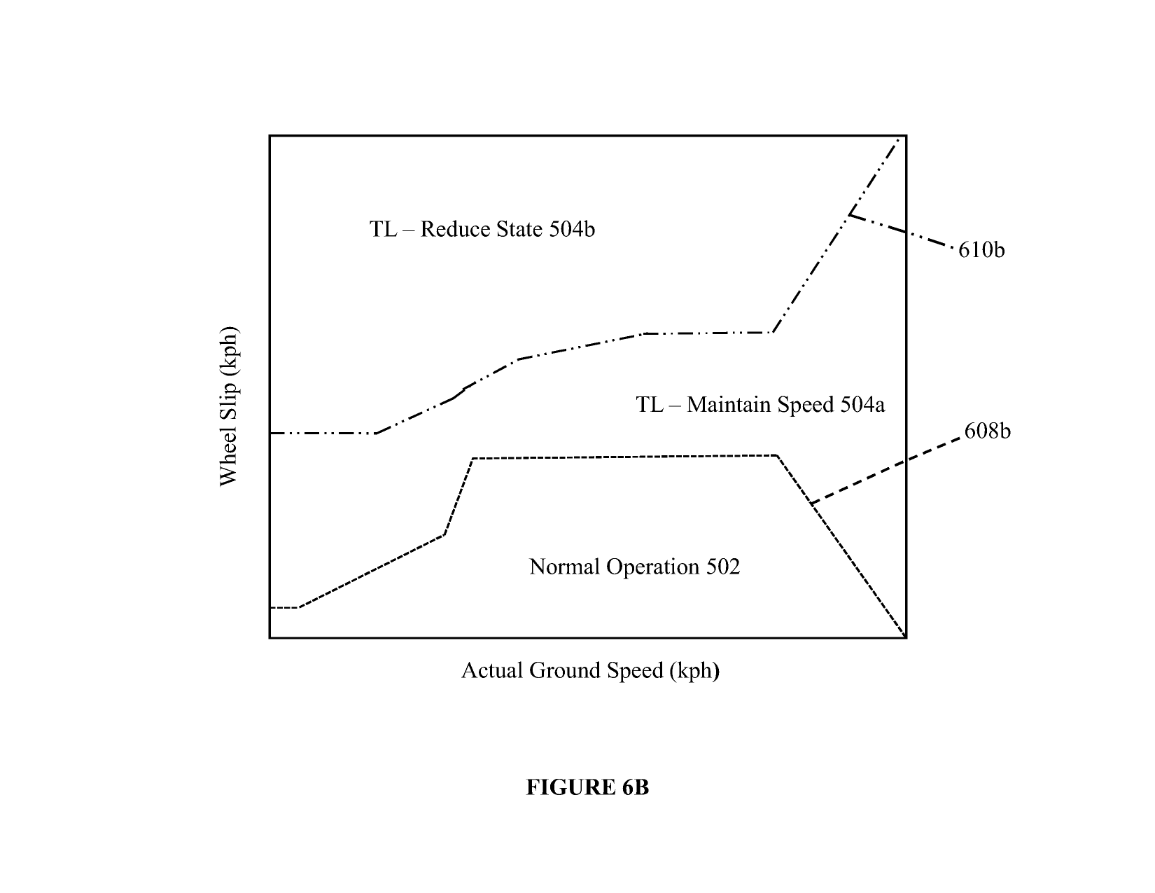

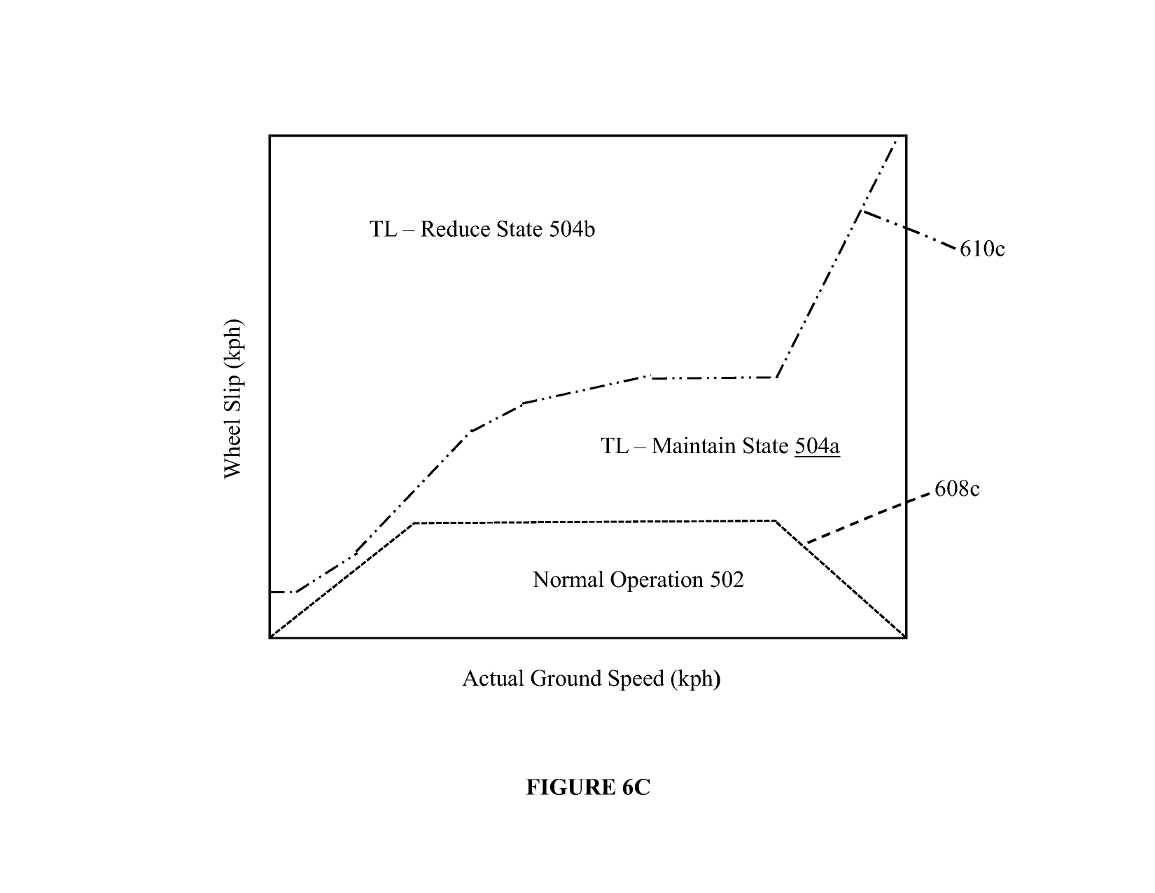

FIGS. 6A, 6B, and 6C illustrate exemplary operations of the ground speed control system 200 when high, medium, and low slip aggressiveness levels are selected, respectively, and when the spinout prevention feature is enabled. Moreover, the exemplary graphs shown in FIGS. 6A, 6B, and 6C depict ranges at which the wheel speed command outputted by at least the ground speed control model 304 is to be based on one of the normal operation state 502, traction limited maintain state 504a, and traction limited reduce state 504b. Additionally, as seen in the illustrated graphs, the horizontal axis corresponds to the actual ground travel speed, in kilometers per hour (kph), of the agricultural vehicle 102, while the vertical axis indicates detected wheel slip, as also represented in slip velocity, as measured kilometers per hour.

As discussed above, the traction limited reduce state 504b relates to the spinout prevention feature of the ground speed control system 200, which is an optional feature that can be selectively enabled or disabled. In the event the spinout prevention feature is disabled, the region shown in FIGS. 6A-6C relating to the traction limited reduce state 504b, as well as the associated, and below-discussed, second boundary 610a-c, may not be present in the illustrated examples, and may not be an available as a ground travel state for the ground speed control model 304. Thus, in the illustrated examples, rather than being limited on an upper end by the illustrated second boundary 610a-c, when the spinout prevention feature is disabled, the traction limited maintain state 504a could occupy both the region identified as the traction limited maintain state 504a and the region in FIGS. 6A-6C identified as the traction limited reduce state 504b.

As shown, in the illustrated examples, the traction limited maintain state 504a is positioned between the normal operation state 502 and the traction limited reduce state 504b. Moreover, in each graph, the traction limited maintain state 504a is separated from the normal operation state 502 by a first threshold 608a-c that, respectively, correspond to the predetermined threshold for the high, medium, and low slip aggressiveness levels (e.g., “MaxSlipMaintain” in FIG. 5), as discussed above. As seen in each graph, each of the predetermined thresholds represented by the illustrated exemplary first thresholds 608a-c can, at certain relatively low actual ground travel speeds, generally increase until reaching a plateau, before declining at relatively higher actual ground travel speeds. Additionally, as discussed above, and as seen in at least the illustrated first thresholds 608a-c in FIGS. 6A, 6B, and 6C, the predetermined threshold for the high slip aggressiveness level is higher than the predetermined thresholds for both the medium and low slip aggressiveness levels at corresponding ground travel speeds. As also demonstrated, the predetermined threshold for low slip aggressiveness level is lower than the predetermined thresholds for both the high and medium slip aggressiveness levels at corresponding ground travel speeds.

As shown in the illustrated examples, the traction limited maintain state 504a is, when slip out prevention features are enabled, positioned below the traction limited reduce state 504b, and separated from the traction limited reduce state 504b by the second threshold 610a-c. The second threshold 610a-c can correspond to the predetermined spinout slip threshold (e.g., “MaxSlipReduce” in FIG. 5), as discussed above. As seen in each graph, each of the predetermined spinout slip thresholds represented by the illustrated second thresholds 610a-c can generally increase with an increase in actual ground travel speed. Additionally, as discussed above, and as seen by the illustrated second thresholds 610a-c, the predetermined spinout slip thresholds can decrease in connection with a decrease in the predetermined thresholds for the high, medium, and low slip aggressiveness levels, respectively.

With respect to the example provided by FIG. 6A, if the speed setpoint is set at point S1 in FIG. 6A, the wheel speed command outputted to the wheel speed master controller may seek to have the wheel speed master controller implement a drive strategy that causes one or more of the ground engagement bodies to have a wheel speed with ground travel speed control disabled. However, in view of at least certain field dynamics, the actual ground speed of the agricultural machine 102 may be lower than the wheel speed command. At point S2 in FIG. 6A, the actual ground speed is increased by the control system 304 with ground speed control enabled with wheel slip below first threshold 608a. As seen by at least the illustrated first threshold 608a in FIG. 6A, in this example, when the actual ground speed is at point S2, the ground speed control model 304 can operate in the normal operation state 502. In some instances, however, the wheel slip may reach a level or range that is slightly above point S3 in FIG. 6A, which is shown as being on the first threshold 608a. Thus, in this example, as the detected wheel slip is not above point S3 on the first threshold 608a, the ground speed control system 200 can operate in the normal operation state 502 in which the ground speed control model 304 can output model wheel speed commands that are to facilitate an increase in the wheel speed of one or more engagement bodies 108 in an attempt to have the actual ground travel speed of the agricultural vehicle 102 attain the speed setpoint. Thus, despite the speed setpoint being set at point S2, the ground speed control model 304 can output model wheel speed commands seeking to have the wheel speed exceed the speed setpoint so as to account for wheel slip when attempting to attain actual ground travel speed equal to the speed setpoint.

In certain situations, despite attempts to attain the speed setpoint by adjusting the wheel speed via one or more model wheel speed commands, the actual ground travel speed may remain relatively unchanged, or not otherwise reach the speed setpoint while the detected wheel slip may increase. Thus, for example, in the event the model wheel speed commands result in the wheel slip exceeding the predetermined threshold for the high slip aggressiveness level while the ground travel speed does not reach the speed setpoint and if the wheel slip is also not exceeding the second threshold 610a, the ground speed control system 200 can enter into the traction limited maintain speed state 504a. As discussed above, when operating in the traction limited maintain speed state 504a, the ground speed control model 304 may seek to maintain the current wheel speed. Thus, in such an example, the ground speed control model 304 may no longer attempt to increase the wheel speed, and thereby may also not seek to have the actual ground travel speed of the agricultural vehicle 102 attain the speed setpoint. Instead, by maintaining the wheel speed, the ground speed control model 304 may be waiting for the agricultural vehicle 102 to reach a location at which the wheel slip drops back into a range associated with the normal operation state 502, and, moreover, below the predetermined threshold for the selected high slip aggressiveness level, as illustrated by first threshold 608a in FIG. 6A. In the event the wheel slip drops back into a range associated with the normal operation state 502, the ground speed control model 304 can then again operate in the normal operation state 502, and again attempt to adjust the wheel speed until either the actual ground travel speed attains the speed setpoint or the wheel slip again exceeds the predetermined threshold.

In certain instances, despite not attempting to increase the wheel speed while operating in the traction limited maintain speed state 504a, the wheel slip may continue to increase, including, for example, increase to a level above the second boundary 610a associated with the predetermined spinout slip threshold. Accordingly, in the event the wheel slip exceeds the predetermined spin out slip, and the spinout prevention feature is enabled, the ground speed control system 200 can change from operating in the traction limited maintain speed state 504a to operating in the traction limited reduce state 504b.

As discussed above, when the ground speed control system 200 is operating in the traction limited reduced state 504b, the ground speed control model 304 may output a model wheel speed command for the wheel speed master controller that reduces the wheel speed, and thereby can reduce the actual ground travel speed of the agricultural vehicle 102. According to certain embodiments, the extent the ground speed control model 304 reduces the wheel speed when the ground speed control system 200 is operating in the traction limited reduced state 504b can be based on a variety of criteria. For example, according to certain embodiments, the ground speed control model 304 can provide a model wheel speed command(s) that reduces the wheel speed such that, at the current actual ground travel speed, the detected wheel slip is at or around, the corresponding predetermined spinout slip threshold shown as point S4 in FIG. 6A. Further, as the actual ground travel speed of the agricultural vehicle 102 continues to decrease in response to reducing the wheel speed, the ground speed control model 304 can continue to provide a model wheel speed commands that further reduces the wheel speed to levels at which the detected wheel slip is at or around the predetermined spin out slip threshold, shown as point S5 in FIG. 6A, for the corresponding actual ground travel speeds. Such an approach can be demonstrated by the ground speed control model 304 outputting, while the ground speed control model 304 operates in the traction limited reduced state 504b, a wheel speed command in which the wheel slip attempting to be attained for a given actual ground travel speed is reflected by the second boundary 610a in FIG. 6A.

Examples similar to those provided above with respect to FIG. 6A are also applicable for the different aggressiveness levels depicted in FIGS. 6B and 6C, including with respect to the different thresholds represented by the exemplary first boundaries 608b, 608c for the aggressiveness levels, as well as for the different predetermined spinout slip thresholds, as represented by the different exemplary second boundaries 610b, 610c.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A system for controlling a wheel speed and a ground travel speed of an agricultural machine, the system comprising:
a ground speed sensor configured to provide information for a determination of an actual ground travel speed of the agricultural machine;
a wheel speed sensor configured to provide information for a determination of a current wheel speed of a ground engagement body of the agricultural machine;
at least one processor; and
a memory coupled to the at least one processor, the memory including instructions that when executed by the at least one processor cause the at least one processor to:
receive a signal indicative of a selected first predetermined threshold for a wheel slip of the ground engagement body;
determine, using at least the actual ground travel speed and the current wheel speed, a current wheel slip, the determination of the current wheel slip being at least periodically updated to reflect a change in at least either or both the current wheel speed and the actual ground travel speed;
generate, if the current wheel slip does not exceed the selected first predetermined threshold for the wheel slip, a first wheel speed signal to increase the current wheel speed, the increase being based at least in part on an attempt to increase the ground travel speed to attain a preselected speed setpoint; and
generate, if the current wheel slip does exceed the first predetermined threshold, a second wheel speed signal to not modify the current wheel speed.

2. The system of claim 1, wherein the memory further includes instructions that when executed by the at least one processor cause the at least one processor to:
identify, based on the selected first predetermined threshold, a second predetermined threshold, the second predetermined threshold corresponding to a higher degree of wheel slip than the first predetermined threshold; and
generate, if the current wheel slip exceeds both the selected first predetermined threshold and the second predetermined threshold, a third wheel speed signal to reduce the current wheel speed.

3. The system of claim 2, wherein the memory further includes instructions that when executed by the at least one processor cause the at least one processor to:
identify, when the current wheel slip no longer exceeds the second predetermined threshold;
generate, in response to the current wheel slip no longer exceeding the second predetermined threshold, a fourth wheel speed signal to either increase or maintain the current wheel speed.

4. The system of claim 1, wherein the memory further includes instructions that when executed by the at least one processor cause the at least one processor to:
detect a state of one or more components or systems of the agricultural machine; and
suspend, at least temporarily and in response to the state of the one or more components or systems, generation of the first wheel speed signal.

5. The system of claim 4, wherein the state of one or more components or systems of the agricultural machine comprises at least one of: a shift in a transmission gear or ratio of the agricultural machine; a stoppage in a travel of the agricultural machine; a direction of the travel of the agricultural machine; and a position of a clutch or a throttle of the agricultural machine.

6. The system of claim 1, wherein the memory further includes instructions that when executed by the at least one processor cause the at least one processor to:
identify a movement of the agricultural machine that satisfies one or more predetermined criteria; and
generate, if the movement of the agricultural machine satisfies the one or more predetermined criteria, a third wheel speed signal to maintain the current wheel speed.

7. The system of claim 6, wherein the movement is a turn, and wherein the one or more predetermined criteria comprise a range of a curvature of the turn.

8. The system of claim 1, wherein the memory further includes instructions that when executed by the at least one processor cause the at least one processor to:
identify a current engine load at speed of the agricultural machine; and
generate, if current engine load at speed satisfies a predetermined criteria, a third wheel speed signal to maintain the current wheel speed.

9. The system of claim 8, wherein the memory further includes instructions that when executed by the at least one processor cause the at least one processor to:
generate, in response to the predetermined criteria being satisfied, a signal to a user interface of the agricultural machine that indicates the agricultural machine is being operated in an underpowered condition.

10. The system of claim 1, wherein the signal indicative of the selected first predetermined threshold is based at least in part on a selection of a slip aggressiveness level by an operator of the agricultural machine, the slip aggressiveness level being selected from a plurality of slip aggressiveness levels, the first predetermined threshold being different for each of the plurality of slip aggressiveness levels.

11. A method for controlling a wheel speed and a ground travel speed of an agricultural machine, the method comprising:
receiving a signal indicative of a selected first predetermined threshold for a wheel slip of a ground engagement body of the agricultural machine;
determining, using at least an actual ground travel speed and a current wheel speed, a current wheel slip of an engagement body of the agricultural machine, the determined current wheel slip being at least periodically updated to reflect a change in at least either or both the current wheel speed and the actual ground travel speed;
generating, if the current wheel slip does not exceed the selected first predetermined threshold, a first wheel speed signal for an increase in the current wheel speed, the increase being based at least in part on an attempt for the actual ground travel speed to attain a preselected speed setpoint; and
generating, if the current wheel slip does exceed the first predetermined threshold, a second wheel speed signal to not modify the current wheel speed.

12. The method of claim 11, further comprising:
identifying, based on the selected first predetermined threshold, a second predetermined threshold, the second predetermined threshold corresponding to a higher degree of wheel slip than the first predetermined threshold; and
generating, if the current wheel slip exceeds both the selected first predetermined threshold and the second predetermined threshold, a third wheel speed signal to reduce the current wheel speed.

13. The method of claim 12, further comprising:
identifying, when the current wheel slip no longer exceeds the second predetermined threshold;
generating, in response to the current wheel slip no longer exceeding the second predetermined threshold, a fourth wheel speed signal to either increase or maintain the current wheel speed.

14. The method of claim 11, further comprising:
detecting a state of one or more components or systems of the agricultural machine; and
suspending, at least temporarily and in response to the state of the one or more components or systems, generation of the first wheel speed signal.

15. The method of claim 14, wherein the state of one or more components or systems of the agricultural machine comprises at least one of: a shift in a transmission gear or ratio of the agricultural machine; a stoppage in a travel of the agricultural machine; a direction of the travel of the agricultural machine; and a position of a clutch or a throttle of the agricultural machine.

16. The method of claim 11, further comprising:
identifying a movement of the agricultural machine as satisfying one or more predetermined criteria; and
generating, if the movement of the agricultural machine satisfies the one or more predetermined criteria, a third wheel speed signal to maintain the current wheel speed.

17. The method of claim 16, wherein the movement is a turn, and wherein the one or more predetermined criteria comprise a range of a curvature of the turn.

18. The method of claim 11, further comprising:
identifying a current engine load at speed of the agricultural machine; and
generating, if current engine load at speed satisfies a predetermined criteria, a third wheel speed signal to maintain the current wheel speed.

19. The method of claim 18, further comprising:
generating, in response to the predetermined criteria being satisfied, a signal to a user interface of the agricultural machine indicating the agricultural machine is being operated in an underpowered condition.

20. The method of claim 11, wherein receiving the signal indicative of the selected first predetermined threshold comprises receiving a selection of a slip aggressiveness level by an operator of the agricultural machine, the slip aggressiveness level being selected from a plurality of slip aggressiveness levels, the first predetermined threshold being different for each of the plurality of slip aggressiveness levels.
